(19) United States
(12) Patent Application Publication
(10) Pub. No.: US 2005/0053338 A1
(43) Pub. Date: Mar. 10, 2005

(54) Single-core bidirectional optical transceiver module

(76) Inventors: Yu-Te Chou, Hsin-Chu City (TW); Chien-Feng Yu, Hsin-Chu (TW)

Correspondence Address: J.C. Patents;Suite 250, 4 Venture, Irvine, CA, 92618, US

(21) Appl. No.: 10/656,008

(22) Filed: Sep. 5, 2003

(51) Int. Cl. G02B 6/36

(52) U.S. Cl. 385/93

(57) ABSTRACT

The present invention related to a single-core bidirectional optical transceiver module, which mainly includes: optical transceiver sleeve, laser diode package, photoelectric sensor, filter glass & combined-seat; wherein, the combined-seat is rectangular, whose surface is made of stainless steel, the part included within it is made of plastic material, to be formed by way of integration; besides it connects with the optical transceiver sleeve at the right side, connects with the laser diode package at the left side, connects again with the photoelectric sensor at its top; such three components are combined in the combined-seat and form an improved structure for single-core optical transceiver module, so as to provide the product of this creation with the advantages of easy workability and low cost.

### BACKGROUND OF THE INVENTION

1. Field of the Invention

The present invention related to a single-core bidirectional optical transceiver module, in particularly, the optical transceiver module is formed through the combined-seat by way of integration; it uses plastic material and stainless steel to combine the optical transceiver sleeve, laser diode package and photoelectric sensor, so as to reduce cost and facilitate the assembly.

2. Description of the Prior Art

General traditional optical transceiver module adopts a light emission component and a light receiving component, which are placed and fixed at the connection part of the upper cover & the lower cover in a separate form; wherein, the light emission component and the light receiving component works separately, the light emission component is laser diode component, used to emit laser light; the light receiving component is optical diode component, used to receive the optical signal sent by the optical fiber, which has the drawbacks of higher cost and difficult to process.

### SUMMARY OF THE INVENTION

The present invention related to a single-core bidirectional optical transceiver module; wherein, the two roles of emission and receiving are integrated in the combined-seat, so as to combine the optical transceiver sleeve, laser diode package and photoelectric sensor; without the separation of the emission component & the receiving component, single outlet can take the roles of emission and receiving; besides the combined-seat is formed by way of integration and adopts composite material, i.e., its appearance is made of stainless steel, the part included within it is made of plastic material, so as to provide the product of this creation with the features of easy workability and low cost.

To make the structure & features and functions of this creation more clear and detailed, the execution example with following graph & figure numbers is offered as below.

### BRIEF DESCRIPTION OF THE DRAWINGS

The other objects and features of the present invention can be more fully understood by referring to the following description of preferred embodiments and accompanying drawing, in which:

FIG. 1 is a section drawing of the present invention;

FIG. 2 is an upper drawing of the present invention;

FIG. 3 is a side drawing of the present invention;

FIG. 4 is a right side drawing of the present invention;

FIG. 5 is a left drawing of the present invention;

FIG. 6 is three-dimensional drawing of the present invention.

### DESCRIPTION OF THE PREFERRED EMBODIMENT

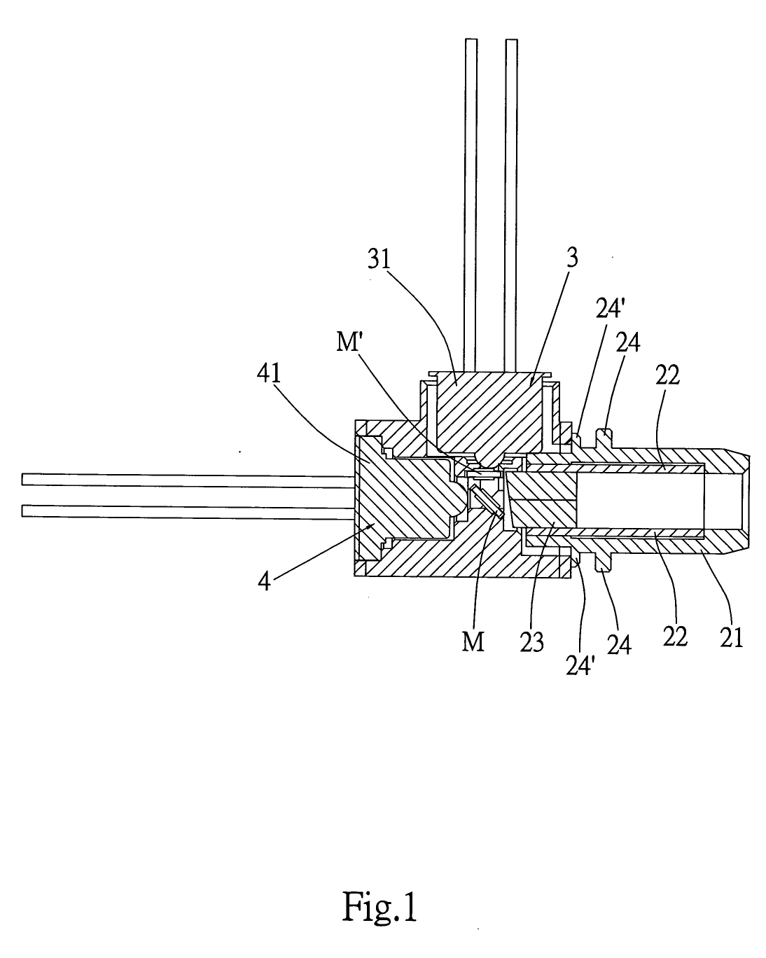

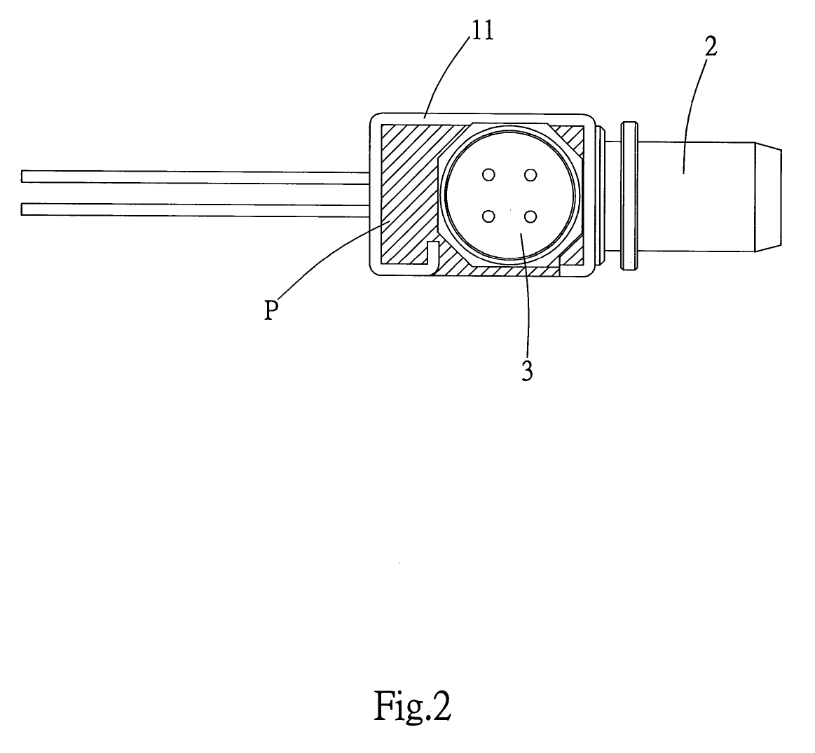

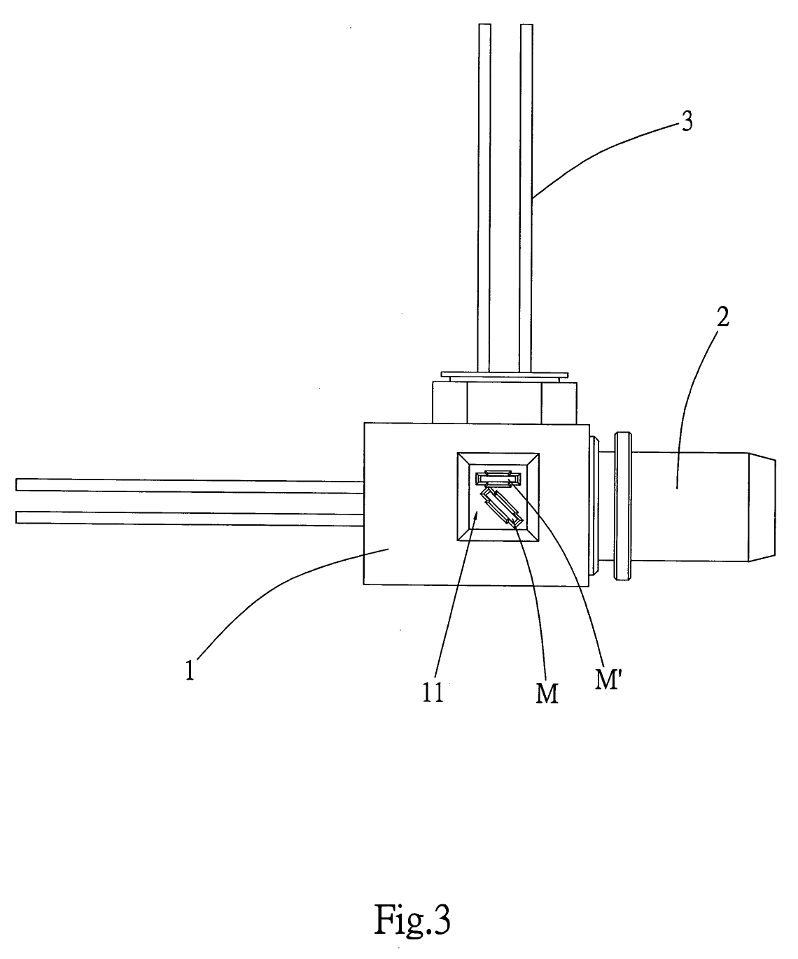

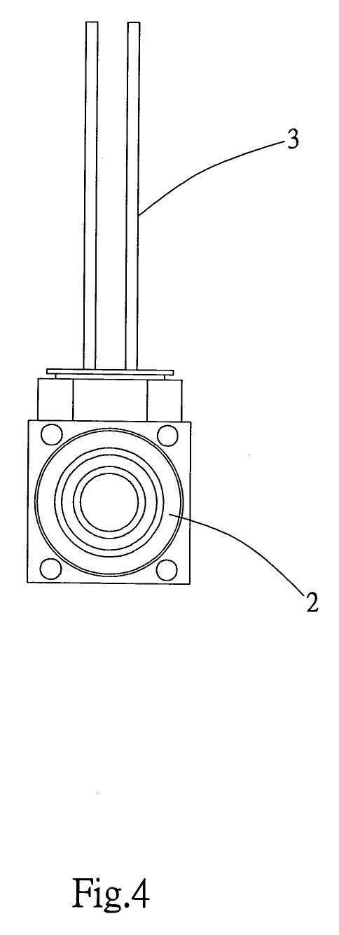

The present invention related to a single-core bidirectional optical transceiver module, as shown in FIG. 1, its optical transceiver module 1′ includes: optical transceiver sleeve 2, laser diode package 4, photoelectric sensor 3, filter mirror M, M′ and combined-seat 1; wherein, the combined-seat 1 is rectangular, which is formed by way of integration spray molding, whose appearance is made of stainless steel, the part included within it is made of plastic material P (indicated by the skew line) as shown in FIG. 2; just as shown in FIG. 3, its side face is equipped with a rectangular hole 11′; and as shown in FIGS. 1 and 3, its filter glass M, M′ is placed at the central part of the combined-seat; wherein, the filter glass M can serve for light reflectance and penetration, while the filter glass M′ serves for filtration; besides, as compared with general product using full stainless steel, it has overall easy workability and low cost; as shown in FIGS. 1, 4 & 6, the optical transceiver sleeve 2 is located on the right side of the combined-seat 1 and serves as the adapter of the optical fiber, so as to insert and form a coupling connection; the housing washer 21 is made of stainless steel, and the part adapting with the combined-seat 1 is equipped with a small flange 24′, while the left side of the small flange 24′ is equipped with flange 24; in addition, the additional inner ring is ceramic ferrule 22 and its inner ring is placed in the ceramic column embolus 23.

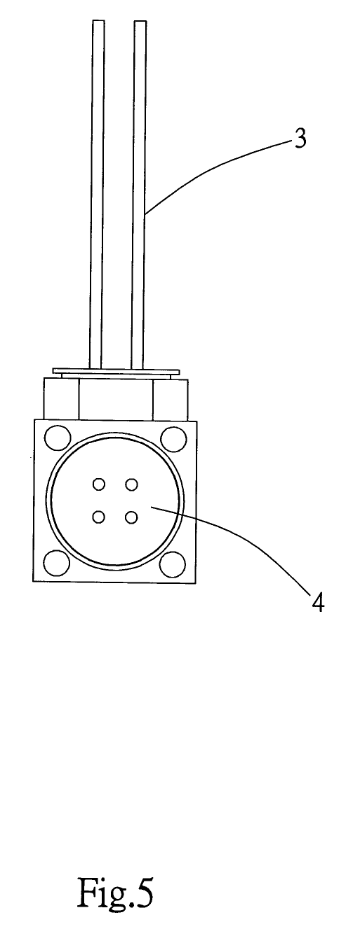

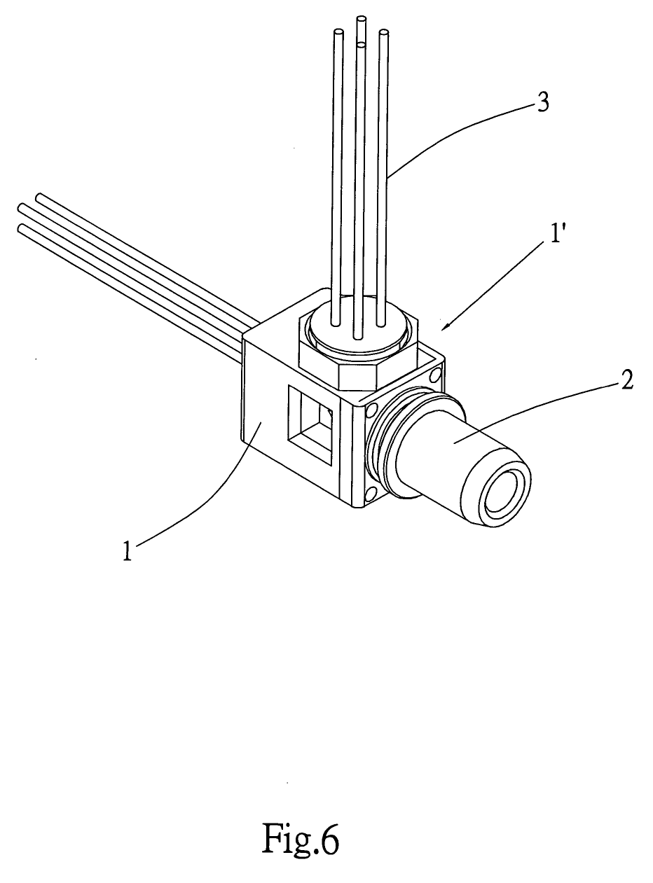

Referring to FIGS. 1, 5 and 6, laser diode package 4 is placed in the left-most side of the combined-seat 1, its convex head 41 is exactly placed in the combined-seat 1; as shown in FIGS. 1, 3, 4, 5 & 6, its photoelectric sensor 3 is placed on the top of the combined-seat 1, its rectangular head 31 is exactly placed on the top of the combined-seat 1.

1. A single-core bidirectional optical transceiver module, which mainly includes: optical transceiver sleeve, laser diode package, photoelectric sensor, filter glass and combined-seat; it features the following: the combined-seat is rectangular, whose surface is made of stainless steel, the part included within it is made of plastic material by way of integration; it connects with the optical transceiver sleeve at the right side, connects with the laser diode package at the left side, connects again with the photoelectric sensor at its top; such three components are combined in the combined-seat and form an optical transceiver module; while the optical transceiver sleeve serves for the insertion combination of the optical fiber to form the optical coupling connection, so as to provide the product of this creation with the advantages of easy workability and low cost.

2. A single-core bidirectional optical transceiver module to claim 1, wherein the combined-seat is a rectangular solid, another side is equipped with a rectangular hole.

3. A single-core bidirectional optical transceiver module to claim 1, wherein the central part of the combined-seat is equipped with two filter-mirrors.

4. A single-core bidirectional optical transceiver module to claim 1, wherein the housing washer of the optical transceiver sleeve is made of stainless steel.

5. A single-core bidirectional optical transceiver module to claim 1, wherein the housing washer of the optical transceiver sleeve is equipped thereon with a small flange and flange.

6. A single-core bidirectional optical transceiver module to claim 1, wherein the inner ring of the optical transceiver sleeve is ceramic ferrule.

7. A single-core bidirectional transceiver module claim 1, wherein the inner ring of the optical transceiver sleeve is equipped therein with a ceramic column embolus.

8. A single-core bidirectional optical transceiver module to claim 1, wherein the graphical head of the laser diode package is placed in the left side of the combined-seat.

9. A single-core bidirectional optical transceiver module to claim 1, wherein the head of the photoelectric sensor is placed on the top of the combined-seat.

10. A single-core bidirectional optical transceiver module to claim 3, wherein the inner ring of the optical transceiver sleeve is ceramic ferrule.
